(19) United States
(12) Patent Application Publication
(10) Pub. No.: US 2009/0327138 A1
(43) Pub. Date: Dec. 31, 2009

(54) Securing Online Transactions

(75) Inventors: Suman Mardani, Bangalore (IN); Santosh Cheler, Bangalore (IN)

Correspondence Address: Ashok Tankha, Esq., 36 Greenleigh Drive, Sewell, NJ, 08080, US

(73) Assignee: AuthWave Technologies Pvt. Ltd.

(21) Appl. No.: 12/113,972

(22) Filed: May 2, 2008

(30) Foreign Application Priority Data
Jan. 28, 2008 (IN) 230/CHE/2008

(51) Int. Cl. G06Q 20/00

(52) U.S. Cl. 705/64; 713/176

(57) ABSTRACT

Disclosed herein is a method and system that addresses the need of securing an online transaction of a consumer. The user is provided with a client application on a mobile device. The user registers the mobile device on a transaction server. The user inputs transaction details for the online transaction on a web portal hosted on the transaction server. The transaction server creates a challenge to the user on a confirmation page to confirm the online transaction. The challenge comprises a challenge code and a transaction confirmation image. The graphical image and the transaction details are computationally inseparable in real time. The user conveys the challenge to the mobile device by inputting the challenge code in the client application. The client application generates a response for the challenge. The user then inputs the response on the confirmation page. The transaction server validates the response and authorizes the online transaction.

### CROSS REFERENCE TO RELATED APPLICATIONS

This application claims the benefit of Indian patent application with number “230/CHE/2008” titled “Securing Online Transactions”, filed on “28 Jan. 2008” in the Indian Patent Office.

### BACKGROUND

This invention, in general, relates to securing an online transaction of a consumer and specifically relates to the authentication of an online transaction of the consumer by a challenge-response sequence.

The easy access to the internet and its widespread use has enabled a variety of business operations between an end consumer and a vendor. These business operations include electronic commerce, online bill payment, electronic transfer of funds, exchange of private information, etc. Carrying out business operations online is strategic to the businesses due to the cost advantage and convenience to the consumers.

A large amount of money and sensitive information is exchanged over the internet on a daily basis and hence has attracted a host of malicious intermediaries intent on finding loopholes in the security system. The most common exploit mechanisms used by the malicious intermediaries include the man-in-the-middle (MITM) attacks, trojan attacks and phishing attacks. In an MITM attack, the attacker intercepts the communication channel established between the end consumer and the business server without either party knowing about the interception and alters the data being exchanged to suit the needs of the attacker.

An MITM attack may be defended against by using cryptographical methods such as encrypting the data to be transferred using encryption algorithms, implementing secure routing protocols, etc. Though the cryptographical methods provide end-to-end network security and reduce the scope of carrying out MITM attacks, these methods may not be effective in minimizing the risk of an MITM attack. There is a need for a method for preventing the attacker from intercepting the communication channel between the consumer and the business server and altering the data being exchanged to suit the needs of the attacker.

In a trojan attack, the attacker remotely installs malware on the computer of the end consumer. Once this malware has been installed the attacker can have access to the consumer supplied information even before the information has been encrypted by the browser. In a phishing attack fake websites masquerade as a trustworthy entity and trick the consumer into providing sensitive information. Since the security of the information being exchanged has been compromised even before the information enters the communication channel, encryption methods are not effective in offering security against trojan attacks and phishing attacks.

There is a need for a method and system to secure and provide protection to online transactions of a consumer against malicious and unauthorized interventions including, but not limited to, MITM attacks, trojan attacks, and phishing attacks.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated need of securing online transactions of a consumer. The user is provided with a client application on a mobile device. The user is provided with a user specific key along with the client application. The user registers the mobile device on a transaction server using the client application and the user specific key. On registering the mobile device the user may be able to use the mobile device to generate responses to challenges presented by the transaction server. After the registration of the mobile device, the transaction server will recognize the responses generated by the client application on the mobile device. The user may access the transaction server through a web portal hosted on the transaction server. To conduct an online transaction the user inputs transaction details on the transaction server via the web portal. In order to confirm an authentic online transaction the transaction server creates a challenge to the user on a confirmation page of the web portal. The challenge comprises a challenge code and a transaction confirmation image. The transaction confirmation image comprises a graphical image overlaid on the transaction details on a randomly generated background. The graphical image and the transaction details are computationally inseparable in real time. The inseparability of the graphical image and the transaction details ensures that the transaction details cannot be extracted in real time and manipulated by malicious interventions such as MITM attacks. The user conveys the challenge to the mobile device by inputting the challenge code in the client application.

After the user inputs the challenge code, the client application on the mobile device displays a plurality of images to the user. The user then selects an image matching the graphical image of the transaction confirmation image. When the user selects the matching image, the client application generates a response. The client application generates the response by utilizing a combination of the selected image, the challenge code, an optional personal identification number provided by the user, and the user specific key. The user inputs the generated response into the transaction server via the web portal and completes the challenge response authentication. The transaction server then validates the response and confirms the online transaction of the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of securing an online transaction of a user.

FIG. 2 illustrates a method for securing an online transaction of the user using text indicia.

FIG. 3 illustrates a system for securing an online transaction of the user.

FIG. 4 exemplarily illustrates a flowchart of a process of registering the mobile device of the user on the transaction server.

FIGS. 5A-5B exemplarily illustrate screen shots of the process of registering the mobile device of the user on the transaction server.

FIG. 6 exemplarily illustrates a screen shot of the challenge comprising a challenge code that is displayed in a visual region unoccupied by the transaction confirmation image.

FIGS. 7A-7C exemplarily illustrate screen shots of the process of generating a response to the challenge by the client application.

FIG. 8A exemplarily illustrates a screen shot of the challenge comprising a challenge code that is a set of predetermined visually highlighted characters in a predefined sequence on the transaction details.

FIG. 8B exemplarily illustrates a flowchart of the challenge-response sequence based on challenge code that is a set of predetermined visually highlighted characters in a predefined sequence on the transaction details.

FIG. 9A exemplarily illustrates a screen shot of a mobile device displaying an image with click points.

FIG. 9B exemplarily illustrates a screen shot of the challenge, wherein the response to the challenge is a plurality of click points on the transaction confirmation image.

FIG. 9C is a flow chart exemplarily illustrating the steps of a challenge-response sequence, wherein the response to the challenge is a plurality of click points on the transaction confirmation image.

FIG. 10A exemplarily illustrates a screen shot of the challenge, wherein the response to the challenge is obtained from text indicia.

FIG. 10B exemplarily illustrates a list of tokens of the text indicia.

FIG. 11 exemplarily illustrates a screen shot of the challenge comprising the challenge code that is overlaid on the transaction confirmation image.

FIG. 12 exemplarily illustrates a screen shot of the challenge comprising a challenge code overlaid on the transaction confirmation image and is used as the response code by the user.

FIG. 13 exemplarily illustrates a screen shot of the mobile device displaying a transaction related question.

### DETAILED DESCRIPTION OF THE INVENTION

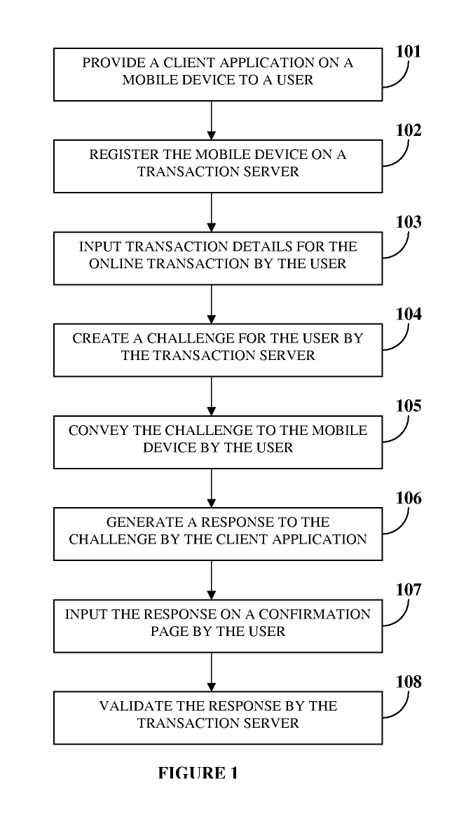

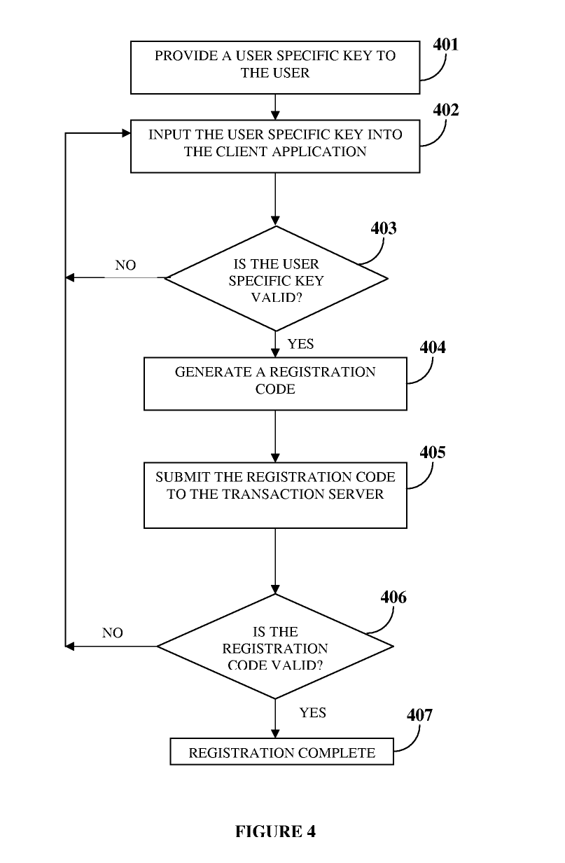

FIG. 1 illustrates a method of securing an online transaction of a user 303. The user 303 is provided 101 with a client application 302 on a mobile device. The mobile device may be one of, but not limited to, a mobile phone, a personal digital assistant (PDA), a handheld computing device, a security token, a hardware device capable of running the client application 302, a software emulation of the client application 302, etc. The user 303 then registers 102 the mobile device on a transaction server 301. The user 303 is provided with a user specific key and uses the user specific key to register the mobile device on the transaction server 301. The registration process of the mobile device is explained in the detailed description of FIG. 4.

The user 303 then logs into a web portal 305 hosted on a transaction server 301 by providing a username and password. The transaction server 301 validates the username and the password. If the username and the password are valid, the transaction server 301 allows the user 303 to carry out an online transaction. For conducting an online transaction the user 303 inputs 103 the transaction details 604 of the online transaction on the web portal 305 hosted on the transaction server 301. The transaction details 604 may include the account number of the user 303, the amount to be transferred, details of the entity to which the amount is to be transferred, type of account of the user 303 to be accessed, etc.

The transaction server 301 then creates 104 a challenge 601 to the user 303 on a confirmation page of the web portal 305 to authenticate and confirm the online transaction. The challenge 601 comprises a challenge code and a transaction confirmation image presented on the confirmation page. The transaction confirmation image comprises a graphical image 603 overlaid on the transaction details on a randomly generated background. The combination of the graphical image 603 and the transaction details 604 are rendered such that they are computationally inseparable in real time.

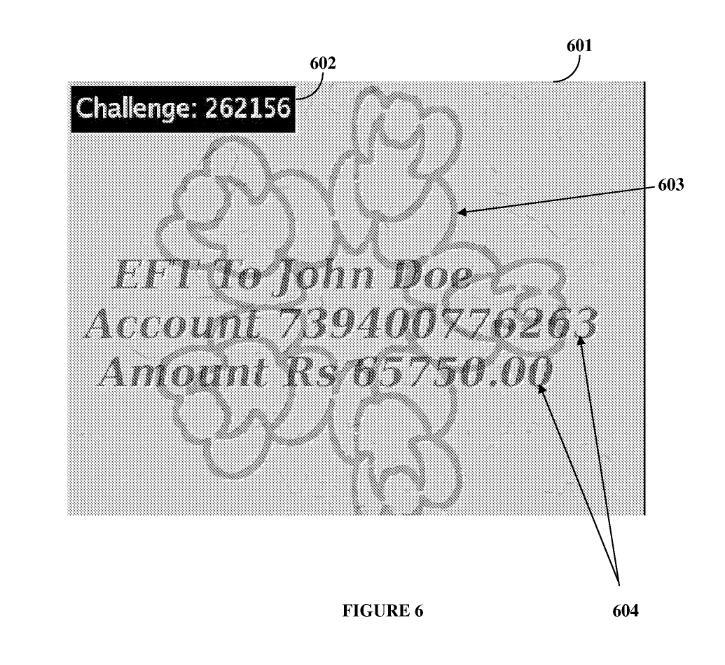

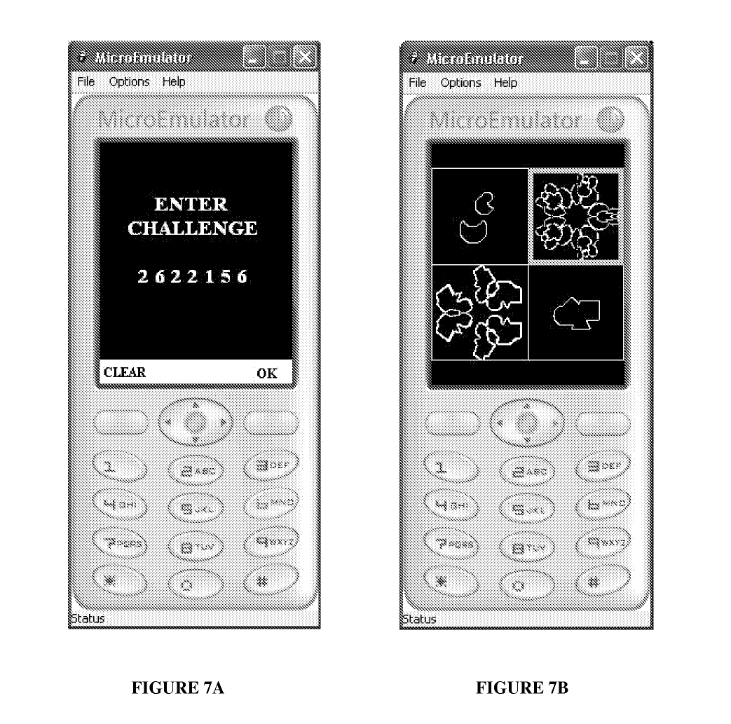

The user 303 conveys 105 the challenge 601 to the mobile device by inputting the challenge code 602 in the client application 302 as illustrated in FIG. 7A. In one embodiment of the method disclosed herein, the challenge code 602 is an alphanumeric string displayed in a visual region unoccupied by the transaction confirmation image as illustrated in FIG. 6. Exemplarily, digital watermarking may be used to combine the graphical image 603 and the transaction details 604 to generate the transaction confirmation image. The transaction confirmation image is rendered such that it is computationally difficult for a malicious intermediary to separate the transaction details 604 from the graphical image 603 or even replace the transaction details 604 of the transaction confirmation image with details of another transaction in real time. The property of the graphical image 603 and the transaction details 604 being computationally inseparable in real time ensures the integrity of the transaction submitted by the user 303 to the transaction server 301.

On the user 303 inputting the challenge code 602 in the client application 302, the client application 302 generates and displays a choice of images to the user 303 on the mobile device as illustrated in FIG. 7B. One of the images displayed by the client application 302 is identical to the graphical image 603 of the transaction confirmation image. The user 303 selects one of the displayed images that match with the graphical image 603 of the transaction confirmation image.

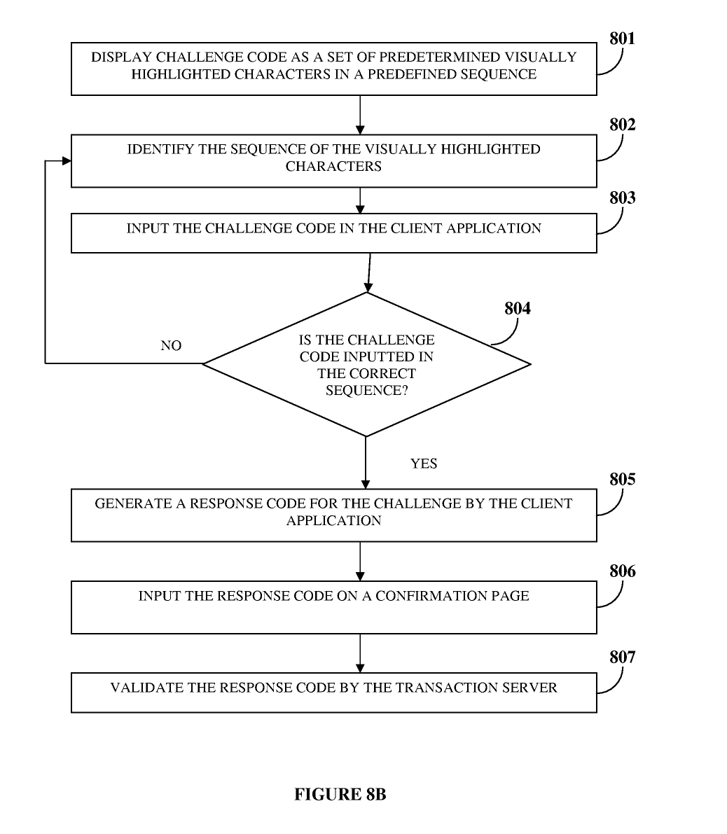

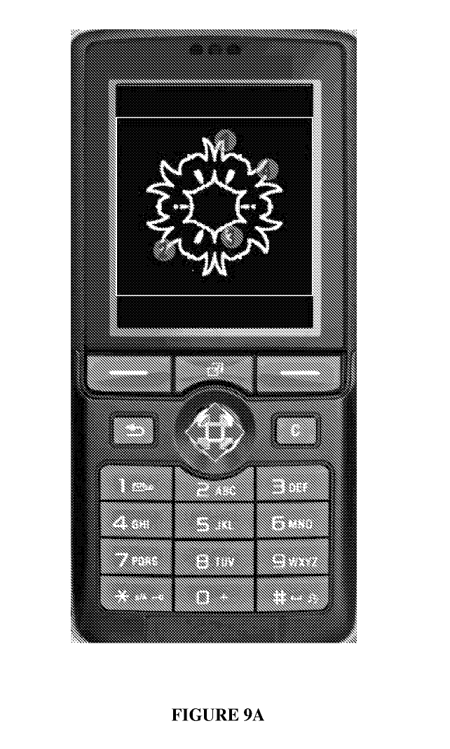

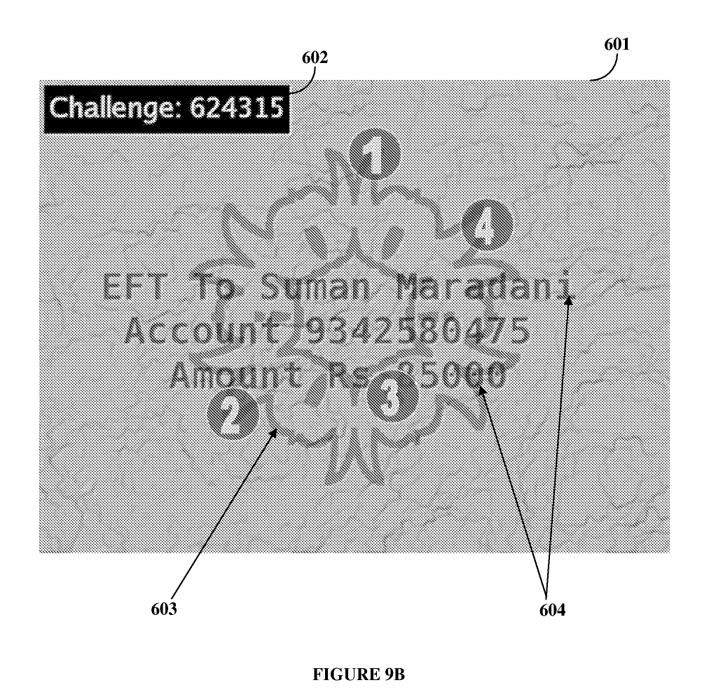

Upon selection of the matching image on the mobile device by the user 303, the client application 302 generates 106 a response for the challenge 601 by utilizing a combination of the selected image, the challenge code 602, the user specific key, and an optional personal identification number. The personal identification number may be required to ensure that only the user 303 has access to the client application 302 on the mobile device. The response may be one of a response code and a plurality of click points to be clicked on the confirmation page. Exemplarily, the response code is a string of alphanumeric characters. The user 303 inputs 107 the generated response on the confirmation page of the web portal 305 to confirm the online transaction. In one implementation of the method, when the response is the response code, the user 303 inputs the response code by inputting the alphanumeric string on the confirmation page. The response comprising the plurality of click points that are used to validate and confirm the online transaction is explained in the detailed description of FIG. 9C. The transaction server 301 then validates 108 the response entered by the user 303. If response is valid, the transaction server 301 authenticates the online transaction and permits the user 303 to carry out the online transaction

The transaction confirmation image exemplarily illustrated in FIG. 6 ensures security of online transaction. If a malicious intermediary modifies the transaction submitted by the user 303 to the transaction server 301, the transaction confirmation image sent back by the transaction server 301 to the user 303 will have the details of the altered transaction. The user 303 sees the transaction details 604 of the altered transaction on the transaction confirmation image and may decline or cancel the transaction. In order to trick the user 303 to confirm the transaction and provide the response code, the malicious intermediary needs to alter the transaction details 604 on the transaction confirmation image to suit the needs of the malicious intermediary and then replace the altered transaction details 604 with the transaction details 604 that the user 303 originally intended to carry out. However, the properties of visible digital watermarking used to generate the transaction confirmation image makes replacing the transaction details 604 in real time computationally difficult. Thus, any attempt by a malicious intermediary to carry out an online transaction that is not initiated by the user 303 will fail.

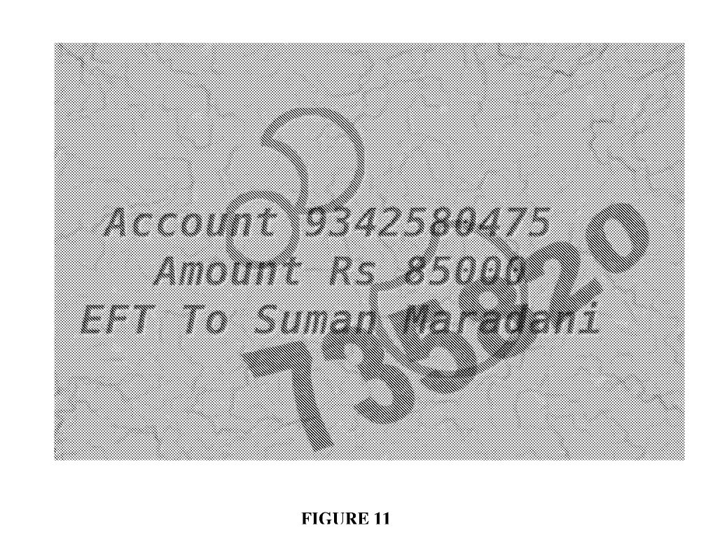

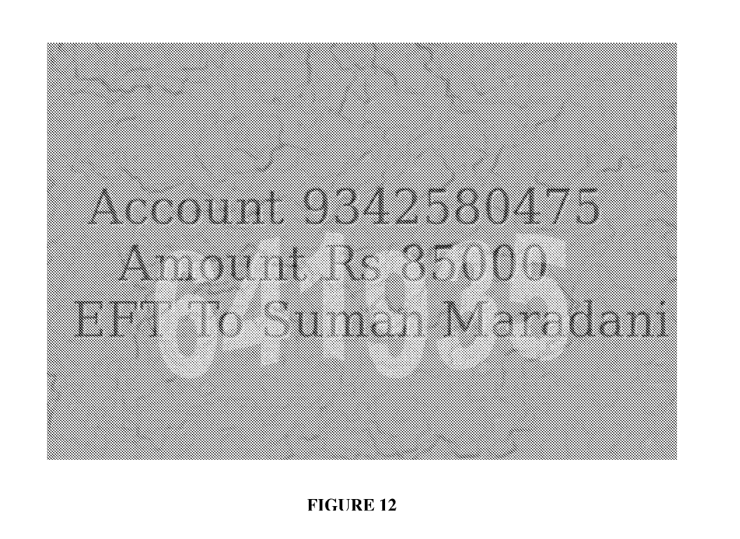

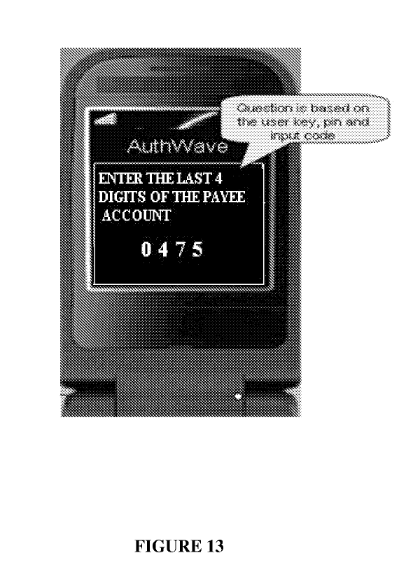

In one embodiment of the method disclosed herein, the challenge code 602 may be overlaid on the transaction confirmation image as illustrated in FIG. 11. The user 303 conveys the challenge 601 to the client application 302 by identifying the overlaid challenge code 602 and inputting the challenge code 602 in the client application 302. In another embodiment the challenge code 602 may be overlaid on the transaction confirmation image and the challenge code 602 itself may be used as the response as illustrated in FIG. 12. In yet another embodiment the user 303 needs to answer a transaction related question generated by the client application 302 prior to the generation of the response by the client application 302. The client application 302 generates the transaction related question using the challenge 601 created by the transaction server 301, an optional personal identification number, and the user specific key. For example, the transaction related question may ask the user 303 to provide the last four digits of the payee account number as illustrated in FIG. 13. The answer provided by the user 303 to the transaction related question is utilized to generate the response by the client application 302.

The transaction confirmation image and the images displayed by the client application 302 may be a static image, a video, animations, etc. In one embodiment, the transaction confirmation image may be a collection of image portions transferred synchronously or asynchronously to the user 303 on a web browser on the user's 303 computing terminal. The image portions are assembled by the web browser or by an image application software on the user's 303 computing terminal and the assembled transaction confirmation image is displayed to the user 303.

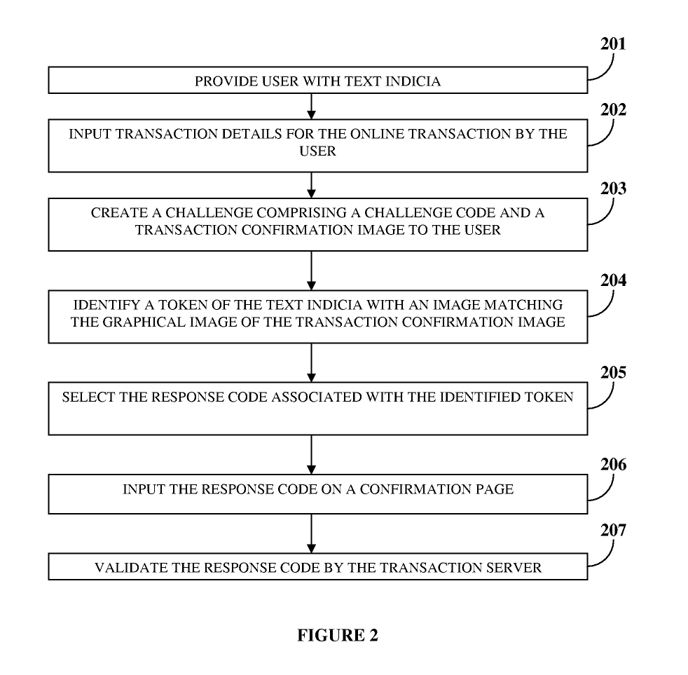

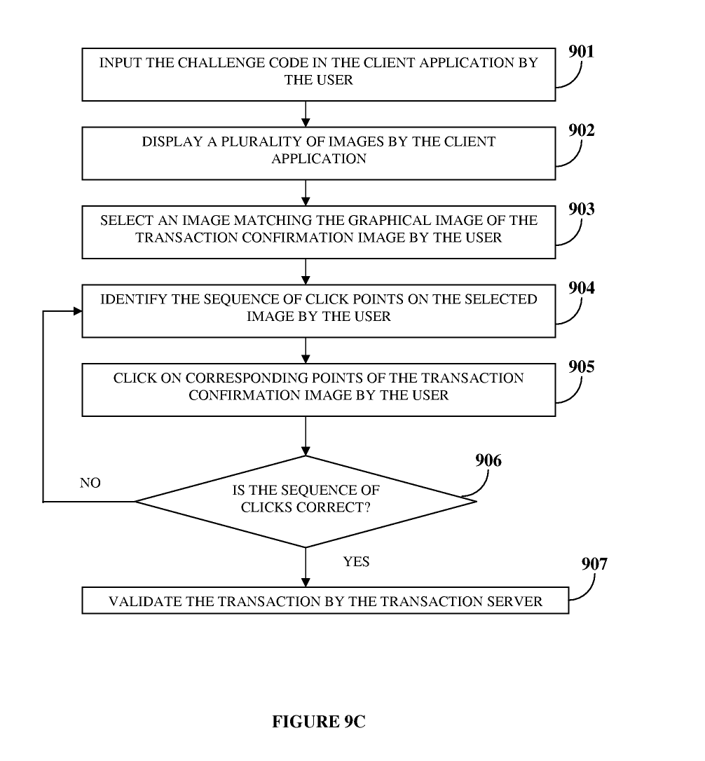

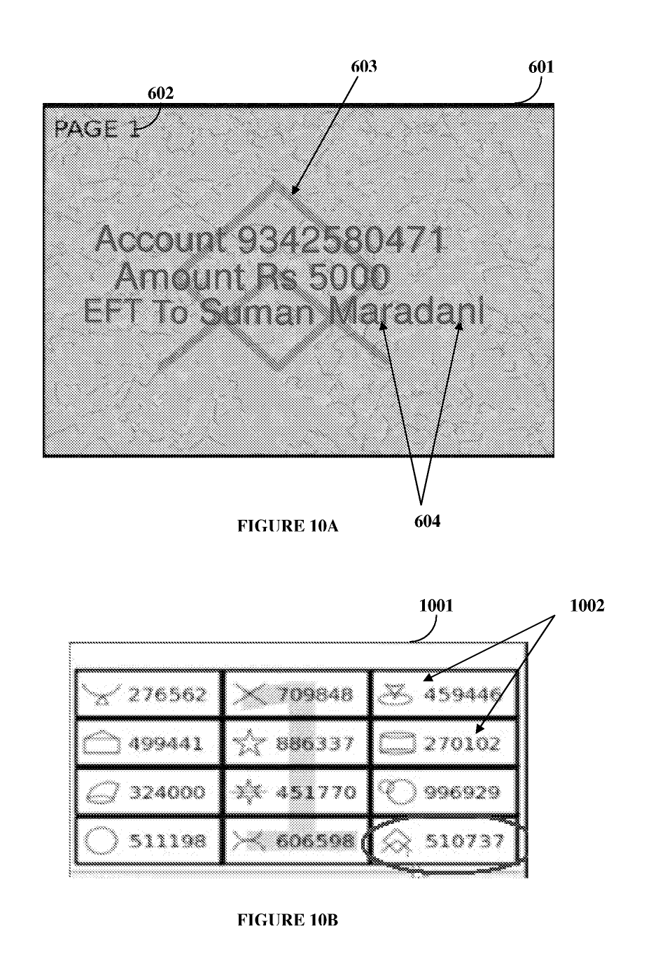

FIG. 2 illustrates a method for securing an online transaction of the user 303 using text indicia 1001 comprising a list of tokens 1002. The user 303 is provided 201 with text indicia 1001 as illustrated in FIG. 10B. The text indicia 1001 comprise a list of tokens 1002 in a set of pages, wherein each of the pages is indexed by a unique page number. Each of the tokens 1002 comprises an image and a response code. The user 303 inputs 202 the transaction details 604 for the online transaction on a web portal 305 hosted on the transaction server 301. The transaction server 301 creates 203 a challenge 601 to the user 303 on a confirmation page of the web portal 305 to confirm the online transaction. The challenge 601 comprises a challenge code 602 and a transaction confirmation image as illustrated in FIG. 10A. The transaction confirmation image comprises a graphical image 603 overlaid on the transaction details 604 on a randomly generated background. The graphical image 603 and the transaction details 604 are computationally inseparable in real time. The challenge code 602 corresponds to a specific page number of the text indicia 1001.

The user 303 selects a page in the text indicia 1001 indexed with the specific page number. The user 303 then identifies 204 a token 1002 with an image matching the graphical image 603 of the transaction confirmation image on the selected page. The user 303 then selects 205 the response code associated with the identified token 1002 and inputs 206 the response code on the confirmation page of the web portal 305. The transaction server 301 then validates 207 the inputted response code to authenticate and confirm the online transaction.

In one embodiment, the text indicia 1001 may comprise a single page in a compact pocket sized form such that the text indicia 1001 is portable. The challenge code 602 comprising a page number is absent and not displayed on the confirmation page by the transaction server 301.

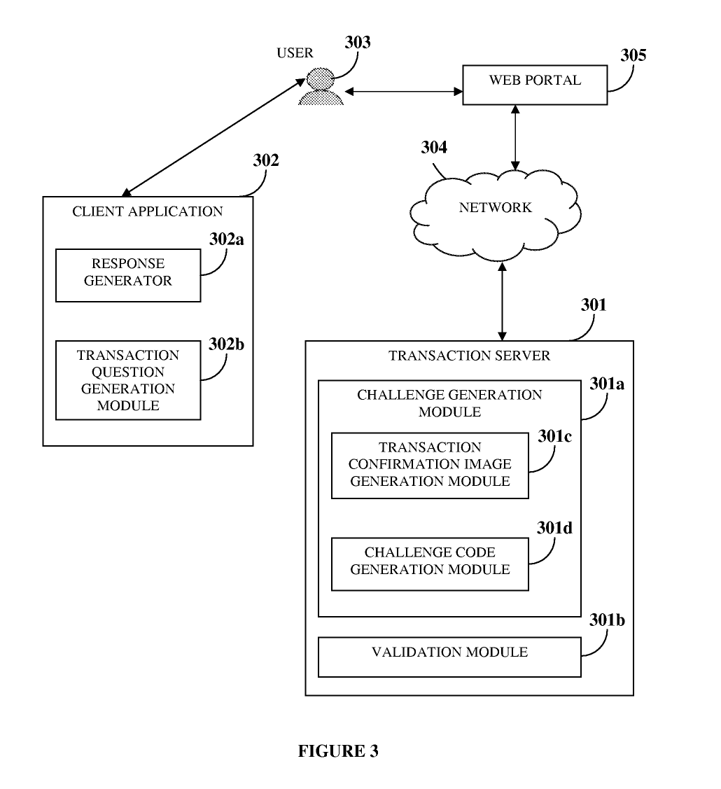

FIG. 3 illustrates a system for securing an online transaction of the user 303. The system disclosed herein comprises a transaction server 301 and a client application 302. The client application 302 is provided on a mobile device of the user 303.

The transaction server 301 is accessed by the user 303 through a web portal 305 via a network 304. The transaction server 301 comprises a challenge generation module 301a and a validation module 301b. The challenge generation module 301a creates a challenge 601 for the user 303 on a confirmation page of the web portal 305. The challenge generation module 301a comprises a transaction confirmation image generation module 301c and a challenge code generation module 301d. The transaction confirmation image generation module 301c generates the transaction confirmation image. The transaction confirmation image comprises a graphical image 603 overlaid on the transaction details 604 of the user 303. The transaction confirmation image generation module 301c renders the transaction confirmation image such that the graphical image 603 is computationally inseparable from the transaction details 604 in real time. The challenge code generation module 301d generates the challenge code 602 used in generating the challenge 601. The validation module 301b on the transaction server 301 validates the response inputted by the user 303.

The client application 302 is used to generate a response to the challenge 601 presented to the user 303 on the confirmation page of the web portal 305. When the user 303 inputs the challenge 601 to the client application 302, the client application 302 displays a plurality of images to the user 303. The user 303 selects one of the displayed images matching with the graphical image 603 of the transaction confirmation image.

The client application 302 comprises a response generator 302a and a transaction question generation module 302b. Once the user 303 has selected the matching image, the response generator 302a generates a response for the challenge 601 inputted to the client application 302 by the user 303. The response generator 302a generates the response utilizing a combination of the selected matching image, the challenge code 602, an optional personal identification number provided by the user 303, and a user specific key. The response may be one of a response code or a plurality of click points.

In one embodiment, the user 303 is required to answer a transaction related question prior to the generation of the response. The transaction question generation module 302b generates the transaction related question. The transaction related question is generated using the challenge created by the transaction server 301, the personal identification number of the user 303, and the user specific key.

The response generated on the client application 302 is inputted by the user 303 to the transaction server 301. The validation module 301b on the transaction server 301 validates the response inputted by the user 303 and permits the user 303 to perform the online transaction.

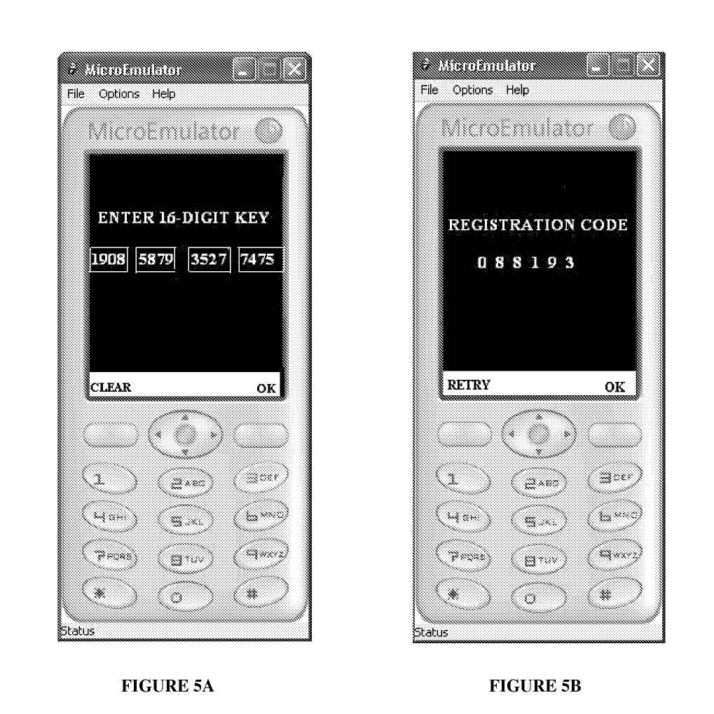

FIG. 4 exemplarily illustrates a flowchart of a process of registering the mobile device of the user 303 on the transaction server 301. The user 303 is provided 401 with a user specific key. The user specific key may be pre-packaged with the client application 302 or could be presented to the user 303 on the web portal 305 of the transaction server 301 or could be delivered to the user 303 via out-of-band channel such as short message service (SMS), electronic mail (email), postal mail, etc. The user specific key, for example, may be a sequence of predefined number of bits represented as an alphanumeric string. For example, the user specific key may be a 16-digit alphanumeric string as illustrated in FIG. 5A. The user 303 inputs 402 the user specific key into the client application 302 on the user's 303 mobile device. The client application 302 validates 403 the user specific key. If the user specific key is valid, the client application 302 generates 404 a unique registration code as illustrated in FIG. 5B. If the user specific key is not valid the client application 302 prompts the user 303 to input the correct user specific key. The user 303 then submits 405 the unique registration code to the transaction server 301. The transaction server 301 then validates 406 the registration code. If the registration code is valid the registration process of the mobile device is completed 407. If the registration code is not valid the transaction server 301 prompts the user 303 to reattempt the registration process using the correct user specific key.

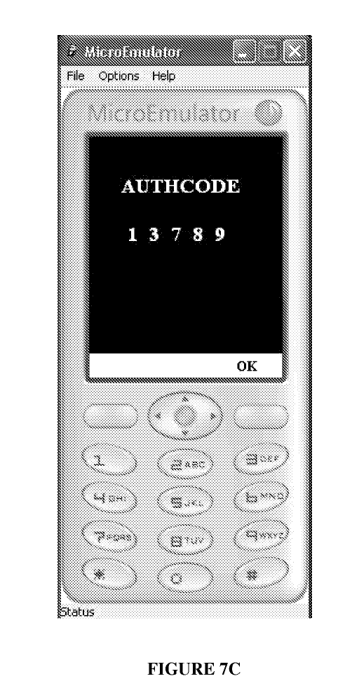

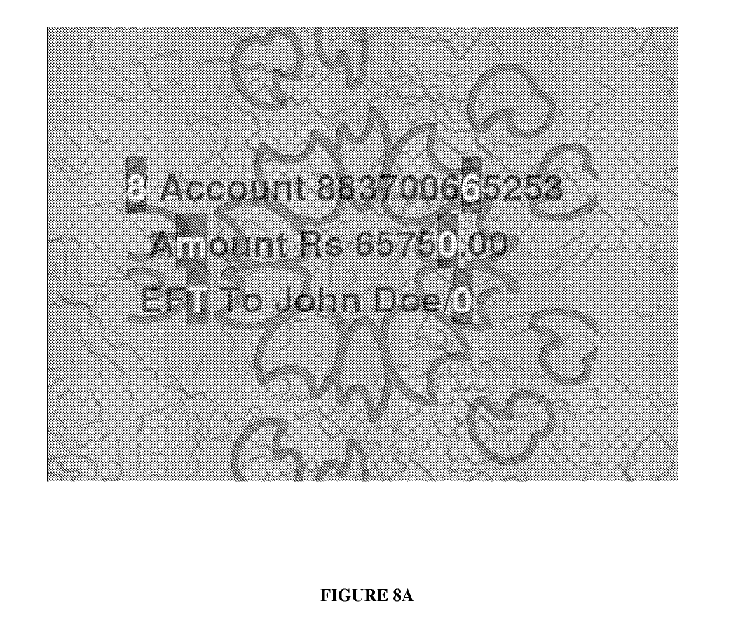

FIG. 8A exemplarily illustrates a screen shot of the challenge comprising a challenge code 602 that is a set of predetermined visually highlighted characters in a predefined sequence on the transaction details 604. FIG. 8B exemplarily illustrates a flowchart of the challenge-response sequence based on challenge code 602 illustrated in FIG. 8A. The transaction server 301 displays 801 the challenge code 602 as a set of predetermined visually highlighted characters in a predefined sequence on the transaction details 604. The user 303 identifies 802 the correct sequence of the highlighted characters to be input as the challenge code 602. The sequence may be any predefined sequence set by the transaction server 301 and known to the user 303. For example, the challenge code 602 is “8-6-m-0-T-0” if the predefined sequence is from left to right as illustrated in FIG. 8A. The user 303 then inputs 803 the challenge code 602 in the client application 302. The client application 302 validates 804 the challenge code 602 by checking if the challenge code 602 is inputted in the correct sequence. The client application 302 generates 805 the response code if the inputted challenge code 602 is valid. The user 303 then inputs 806 the response code on a confirmation page of a web portal 305. The transaction server 301 validates 807 the response code and if the response code is correct permits the user 303 to carry out the online transaction.

FIG. 9A exemplarily illustrates a screen shot of a mobile device displaying an image with click points. FIG. 9B exemplarily illustrates a screen shot of the challenge, wherein the response to the challenge is the plurality of click points on the transaction confirmation image. FIG. 9C exemplarily illustrates a flowchart based on the challenge illustrated in FIG. 9B. The user 303 inputs 901 the challenge code 602 in the client application 302. The client application 302 displays 902 a plurality of images to the user 303 as illustrated in FIG. 7B. The user 303 then selects 903 an image matching the graphical image 603 of the transaction confirmation image. The selected image is marked with a sequence of click points by the client application 302 as illustrated in FIG. 9A. Each of the click points displayed on the selected image comprises a spatial location relative to the selected image and exemplarily a number indicating a position in the sequence in which the click point is to be clicked. The user 303 identifies 904 the spatial locations and the sequence of click points displayed on the selected image and clicks 905 on the corresponding spatial locations on the transaction confirmation image in the identified sequence. The transaction server 301 validates 907 the transaction if the click points clicked by the user 303 are in the correct 906 spatial locations and sequence. If the sequence of click points clicked by the user 303 is incorrect the transaction server 301 prompts the user 303 to correctly identify the sequence of click points. The click points depicted in the challenge shown in FIG. 9B is for illustration purposes and may not appear on the challenge created by the transaction server 301 on the confirmation page.

It will be readily apparent to those skilled in the art that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product, comprising computer executable instructions embodied in a computer-readable medium, comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of securing an online transaction of a user, comprising the steps of:
providing a client application on a mobile device of said user;
registering said mobile device of the user on a transaction server;
inputting transaction details by the user for said online transaction on a web portal hosted on said transaction server;
creating a challenge to the user by the transaction server on a confirmation page of said web portal to confirm the online transaction, wherein said challenge comprises a challenge code and a transaction confirmation image, wherein said transaction confirmation image comprises a graphical image overlaid on said transaction details on a randomly generated background, wherein said graphical image and the transaction details are computationally inseparable in real time;
conveying the challenge to the mobile device by the user by inputting said challenge code in said client application;
generating a response for the challenge by the client application;
inputting said response on said confirmation page by the user; and
validating said inputted response by the transaction server;
whereby the challenge created by the transaction server and the response generated by the client application are used for securing the online transaction of the user.

2. The computer implemented method of claim 1, wherein the step of registering the mobile device of the user comprises the steps of:
providing the user with a user specific key by the transaction server;
inputting said user specific key into the client application by the user;
generating a registration code by the client application by validating the user specific key; and
said registering of the mobile device on the transaction server by providing said registration code to the transaction server by the user.

3. The computer implemented method of claim 1, wherein said step of generating the response for the challenge comprises the steps of:
displaying a plurality of images on the mobile device by the client application;
selecting one of said displayed images matching said graphical image of the transaction confirmation image by the user; and
generating the response by the client application utilizing a combination of said selected image, the challenge code, an optional personal identification number provided by the user, the user specific key, wherein the response is one of a response code and a plurality of click points in a displayed sequence.

4. The computer implemented method of claim 2, wherein the user specific key is an alphanumeric string and stored as a sequence of bits on the mobile device of the user.

5. The computer implemented method of claim 3, wherein said click points are inputted as the response by the user, wherein said step of inputting the response comprises the steps of:
identifying said displayed sequence of the click points by the user on the client application; and
clicking on corresponding click points on the transaction confirmation image by the user in the displayed sequence.

6. The computer implemented method of claim 1, wherein the challenge code is an alphanumeric string displayed on the confirmation page in a visual region unoccupied by the transaction confirmation image.

7. The computer implemented method of claim 1, wherein the challenge code is a set of predetermined visually highlighted characters in a predefined sequence on the transaction details, further wherein the user inputs the challenge code into the client application in said predefined sequence.

8. The computer implemented method of claim 1, wherein the challenge code is overlaid on the transaction confirmation image on the confirmation page.

9. The computer implemented method of claim 8, wherein the challenge code overlaid on the transaction confirmation image is used as the response code by the user.

10. The computer implemented method of claim 1, wherein the user answers a transaction related question generated by the client application, wherein said transaction related question is generated using the challenge created by the transaction server, an optional personal identification number, and the user specific key, wherein said answer provided by the user to the transaction related question is utilized to generate the response by the client application.

11. The computer implemented method of claim 1, wherein the transaction confirmation image and said images displayed by the client application are one of static images, videos, and animations.

12. The computer implemented method of claim 11, wherein the transaction confirmation image is transferred to the user on a web browser as a collection of image portions, wherein said image portions are assembled by one of said web browser and an image application software to display the transaction confirmation image on the web browser.

13. The computer implemented method of claim 1, wherein the mobile device is one of a mobile phone, a security token, a software emulation of the client application, and a hardware device capable of running the client application.

14. A computer implemented method of securing an online transaction of a user, comprising the steps of:
providing said user with text indicia, wherein said text indicia comprises a list of tokens in a set of pages indexed by page numbers, wherein each of said tokens comprises an image and a response code;
inputting transaction details by the user for said online transaction on a web portal hosted on a transaction server;
creating a challenge to the user by said transaction server on a confirmation page of said web portal to confirm the online transaction, wherein said challenge comprises a challenge code and a transaction confirmation image, wherein said transaction confirmation image comprises a graphical image overlaid on said transaction details on a randomly generated background, further wherein said challenge code corresponds to a specific page number of the text indicia;
identifying a token with an image matching the graphical image of the transaction confirmation image on a page with said specific page number;
selecting said response code associated with said identified token;
inputting the response code on said confirmation page by the user; and
validating said inputted response code by the transaction server.

15. The computer implemented method of claim 14, wherein the text indicia comprises a single page.

16. The computer implemented method of claim 15, wherein the challenge code is absent.

17. A computer implemented system for securing an online transaction of a user, comprising:
a transaction server comprising:
a challenge generation module for creating a challenge to said user;
a validation module for validating a response generated for said challenge; and
a client application on a mobile device of the user for generating said response.

18. The computer implemented system of claim 17, wherein said challenge generation module comprises:
a transaction confirmation image generation module for generating a transaction confirmation image, wherein said transaction confirmation image comprises a graphical image overlaid on transaction details of the user on a randomly generated background; and
a challenge code generation module for generating a challenge code.

19. The computer implemented system of claim 17, wherein said client application comprises:
a response generator for generating the response, wherein the response is one of a response code and a plurality of click points in a predefined sequence; and
a transaction question generation module for generating a transaction related question to the user, wherein said transaction related question is generated using the challenge created by the transaction server, the personal identification number of the user, and the user specific key.

20. A computer program product comprising computer executable instructions embodied in a computer readable medium, wherein said computer program product comprises:
a first computer parsable program code for creating a challenge to the user on a confirmation page by a transaction server;
a second computer parsable program code for generating a transaction confirmation image;
a third computer parsable program code for generating a random challenge code;
a fourth computer parsable program code for generating a transaction related question;
a fifth computer parsable program code for generating a response to said challenge; and
a sixth computer parsable program code for validating said generated response.
